(19) United States
(12) Patent Application Publication
(10) Pub. No.: US 2012/0310810 A1
(43) Pub. Date: Dec. 6, 2012

(54) METHOD AND SYSTEM OF ENTERING POSITIONS REGARDING SECURITIES

(75) Inventor: Haskell E. Downs, II, Austin, TX (US)

(73) Assignee: NIRVANA SYSTEMS, INC., AUSTIN, TX (US)

(21) Appl. No.: 13/151,723

(22) Filed: Jun. 2, 2011

(51) Int. Cl. G06Q 40/00

(52) U.S. Cl. 705/37

(57) ABSTRACT

Entering positions regarding securities. At least some of the illustrative embodiments include: interacting by a trader with a physical device, the interacting sets purchasing power for entering positions regarding securities; and without further input by the trader selecting a plurality of securities from a preselected list of securities, the selecting based on one more indications for each security, and the selecting by a computer system; and entering a plurality of positions regarding the plurality of securities, the number and value of the plurality of positions limited by the purchasing power, and the entering initiated by the computer system.

### BACKGROUND

A variety of programs are available to assist investors with trading securities (e.g., stocks). However, while the programs may have many features that help the investor identify securities of interest, the programs are limited and cumbersome with regard to actually entering positions regarding securities. In many cases, such programs require the investor to enter positions one security at a time. In other cases, positions may be entered regarding a predetermined set of securities (i.e., as “basket” of securities), but such basket positions are all or nothing—positions regarding the “basket” are entered, if at all, as a group.

Any advance which makes selecting position parameters, and entering positions, regarding a group of securities easier and/or faster for the investor would provide a competitive advantage in the marketplace.

### BRIEF DESCRIPTION OF THE DRAWINGS

For a detailed description of exemplary embodiments, reference will now be made to the accompanying drawings in which:

FIG. 1 shows a block diagram of a system in accordance with at least embodiments;

FIG. 2 shows a more detailed block diagram of a system in accordance with at least embodiments;

FIG. 3 shows a user interface for a signal generation program, and a user interface for a position control program, in accordance with at least some embodiments;

FIG. 4 shows a system in accordance with at least embodiments;

FIG. 5 shows control devices in accordance with at least embodiments;

FIG. 6 shows a method in accordance with at least embodiments; and

FIG. 7 shows a computer system in accordance with at least embodiments.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection or through an indirect connection via other devices and connections.

“Security” shall mean a negotiable (i.e., transferrable) financial instrument, whether represented by certificate or non-certificated. Security shall include debt securities and equity securities.

“Position” with respect to a security shall mean entering a long transaction regarding the security and/or entering a short transaction regarding the security.

“Long transaction” shall mean a transaction with respect to a security in which an interest in a security is purchased, and the security is sold at a later time.

“Short transaction” shall mean a transaction with respect to a security in which a security is borrowed and sold, and then a replacement security is purchased and returned at a later time. Short transaction shall also include situations where a security is sold without having a security to provide, and then the security is purchased and provided at a later time.

“Signal”, with respect to a security, shall mean an indication of a recommendation regarding a position with respect to the security.

“Stop loss” shall mean a set of circumstances with respect to a position at which action takes place. Stop loss shall not be limited only to long transactions.

“Remote” with respect to a computer system shall mean a distance of greater than one kilometer.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The various embodiments are directed to methods and related systems of selecting parameters for entering positions regarding securities, and entering those positions based on the selected parameters. The discussion first turns to a high level overview of the various entities and systems to implement the embodiments, and then discusses illustrative embodiments for selecting the parameters regarding the positions.

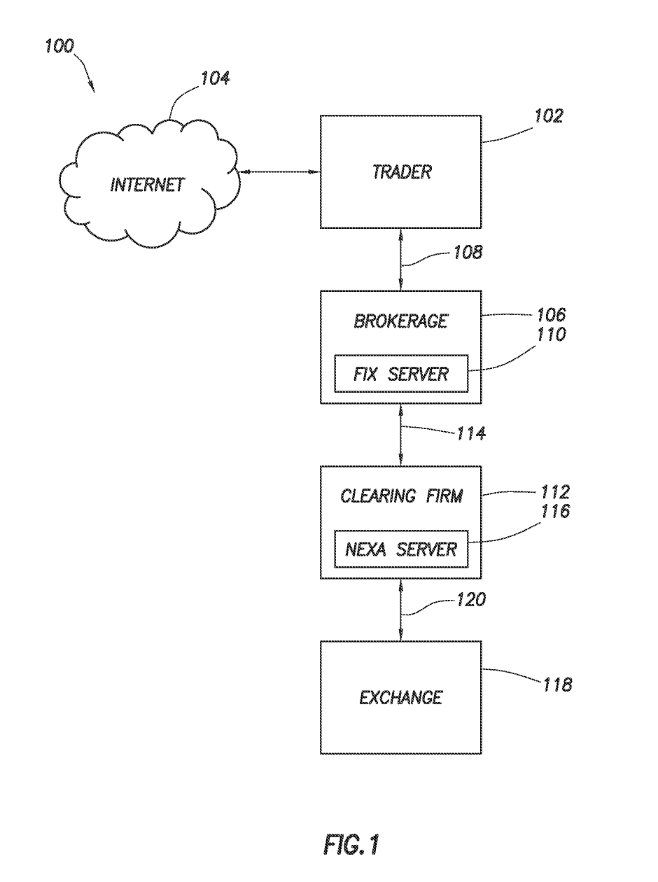

FIG. 1 shows an illustrative system 100 with which positions regarding securities may be entered and exited. In particular, at the top level is the trader 102. The trader 102, and more particularly a program operated by the trader 102, gathers information from any available source, such as the Internet 104, regarding securities. The information gathered may include not only data about specific securities (e.g., historical pricing, open price, close price, current trading price), but also information that may indirectly affect price of the security, such as information from local or national news feeds, and securities and exchange commission filings. Based on the gathered information, the trader 102 electronically initiates entering of positions regarding one or more securities. The positions may be long transactions (where the trader believes the price of the security will rise with time), short transactions (where the trader believes the price of the security will fall with time), or combinations across a spectrum of different securities.

In order to initiate entering of the one or more positions regarding one or more securities, the trader 102 electronically communicates with a brokerage 106 by way of communication channel 108. In some cases, the communication channel 108 may be a direct and/or dedicated communication channel between the trader 102 and the brokerage 106 (e.g., point-to-point T1 connection). In other cases, the communication over the communication channel 108 may be by way the Internet. In one embodiment, the trader 102 communicates with a Financial Information eXchange (FIX) protocol server 110 owned or controlled by the brokerage 106. FIX is a transaction protocol for trade-related message, which protocol may be implemented in software on a server, hence the term “FIX server”. Information regard the FIX protocol may be obtained from the FIX standards managing organization, at www.fixprotocol.org. The FIX server 110 tracks information regarding the trader 102, such as account balances, list of ownership interests, lists of positions regarding securities, and pending or “in-flight” transactions. Other messaging protocols between the trader 102 and the brokerage 106 may be equivalently used.

Positions initiated by the trader 102 by way of the brokerage 106 are then communicated to a clearing firm 112 by way of a communication channel 114. In some cases, the communication channel 114 may be a direct and/or dedicated communication channel between the brokerage 106 and the clearing firm 112. In other cases, the communication over the communication channel 114 may be by way the Internet. A clearing firm is an entity that provides services regarding confirmation, delivery, and settlement of transactions regarding securities. The clearing firm 112 may sometimes be referred to as “clearing corporations” or “clearing houses”. In a particular embodiment, the brokerage 106 communicates with the clearing firm 112 by way of a Nexa Server 116 under the custody and/or control of the clearing firm 112. Nexa servers may be available from Nexa Technologies of Irvine, Calif.

The clearing firm 112, in turn, implements the trades by communication with an exchange 118 by way of communication channel 120. The communication channel 120 may be a direct and/or dedicated communication channel between the clearing firm 112 and the exchange 118, and in other cases the communication over the communication channel 114 may be by way the Internet. The exchange 118 is any organization which implements a marketplace for the transfer of securities, such as the New York Stock Exchange (NYSE), or the Chicago Mercantile Exchange.

The exchange 118 may deal with multiple clearing firms 112. Clearing firm 112 may deal with multiple brokerages 106. Brokerage 106 may have many customers in the form of traders 102. FIG. 1 is thus a simplified, and is presented to orient the reader to the layers of organizations and communications used to implement entering and existing positions (i.e., buying and selling) regarding securities. One note before focusing more specifically at the trader 102 level is that while the communications to initiate and implement the positions are electronic and operate very quickly, such communications, and the trades implemented responsive to the communications, are not instantaneous. There is a finite amount of time between when a trader 102 initiates a trade, and when the trade may actually take place at the exchange 118. Moreover, within that period of time the exchange price for a security may have changed from the price at the point in time when the trader 102 initiates the trade.

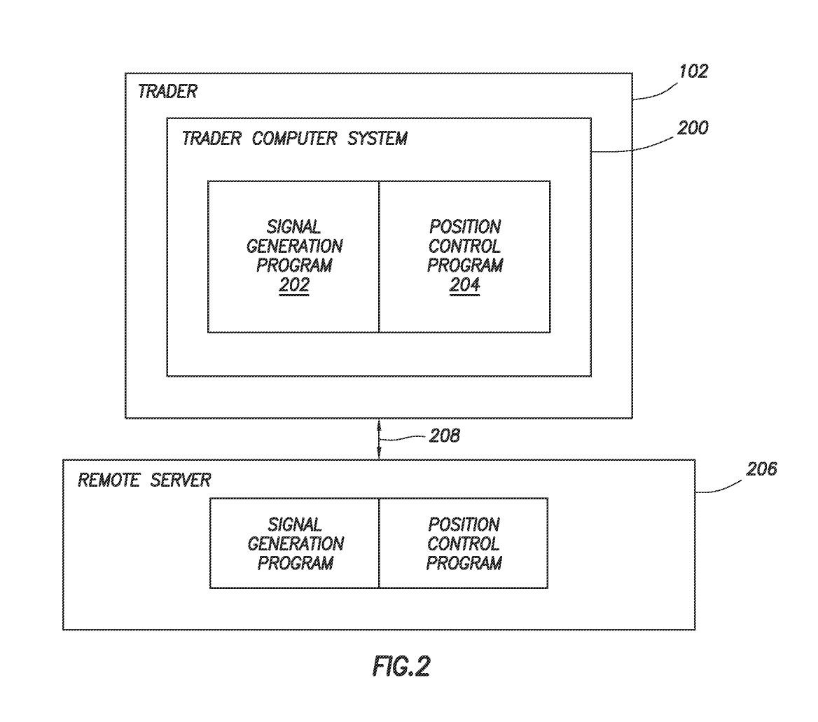

FIG. 2 illustrates in greater detail various systems and programs associated with the trader 102. In particular, the trader 102 may implement a trader computer system 200. The trader computer system 200 may take any suitable form, such as a laptop computer, a desktop computer, a server computer system, a hand-held computer system (e.g., a smart phone, various pad-type computer systems). The trader computer system 200 in accordance with at least some embodiments executes one or more programs, illustratively labeled signal generation program 202, and position control program 204. Each program is discussed more below. However, FIG. 2 also illustrates that the signal generation program 202 and position control program 204 can be executed by a remote server 206, with the user interfaces sent to the trader computer system 200 over communication channel 208 (e.g., the Internet). In one embodiment the remote server 206 is under the custody and control of the trader 102, and in another embodiment the remote server 206 is under the control of a third party, such as the brokerage 106. In the case of the signal generation program 202 and position control program 204 being remotely executed, the trader computer system 200 may interface through any suitable interface program, such as a web browser or dedicate remote client program.

In accordance with at least some embodiments, the signal generation program 202 tracks a preselected list of securities over time. The securities that the signal generation program 202 tracks may be directly designated by the trader 102, may be an “out-of-the-box” list of securities, or may be a full or partial list designated by some other entity (e.g., the publically traded companies that make up the Dow Jones Industrial Average, some or all the companies on the Russell 2000 Index, Fortune 500 companies designated yearly by Fortune® Magazine). Moreover, the signal generation program 202 automatically generates one or more signals for each security, and the signals may change with time. In accordance with the various embodiments, the signals generated may be viewed as recommendations regarding positions relating to a security, such as to enter a position, or to exit a position. Moreover, each signal may directly or indirectly suggest a type of position, such a long transaction or a short transaction.

Each signal may be based on an underlying strategy. Strategies may be user defined, or may be “out-of-the-box” strategies provided by the manufacturer of the of the signal generation program 202. For example, a signal may be generated regarding a particular security if the trading for the particular security experiences a breakout condition. That is, if trading price for the security has been within a statistically small range, and the security then experiences a breakout of the range (above or below), such a breakout may create a signal regarding the security. For example, a breakout in the positive direction (trade price increasing) may create a signal that suggests entering a long transaction for the security. Likewise, a breakout in the negative direction (trade price decreasing) may create a signal that suggests entering a short transaction for the security.

Another illustrative strategy may be analyzing trading for price reversals. That is, if the trading price for a security has been on a statistically downward trend, and the trading price makes a statistically significant upturn, a signal may be generated that suggests entering a long transaction for the security. Likewise, if the trading price for a security has been on a statistically upward trend, and the trading price makes a statistically significant downturn, a signal may be generated that suggests entering a short transaction for the security.

The breakout and reversal strategies are merely illustrative of strategies that may be implemented, and should not be read as a limitation on the signals created. Moreover, the breakout and reversal strategies are both price-based, but strategies may also be based on non-price information, such as time of year, proximity to a major event (annual shareholders meeting), or announcement of stock split.

Moreover, the one or more signals created regarding a particular security need not themselves directly suggest a position, but may reinforce another signal for the same security or a different security. For example, the signal generation program 202 may create a signal that recommends a long transaction for a particular security. Taking into account other information, further signals may be generated that reinforce the signal that recommends the long transaction (e.g., matching trend in the Dow Jones Industrial average). As another example, a signal may be based on an underlying positive breakout, and a reinforcing signal may be based on a positive breakout for a similarly situated security (e.g., a security classified in the same business sector).

Any of variety of signal generation programs 202 may be used to track the preselected list of securities and create signals. For example, VisualTrader program available from Nirvana Systems, Inc. of Austin, Tex., may be used as the signal generation program 202.

Still referring to FIG. 2, in accordance with the various embodiments the trader also utilizes position control program 204. Position control program 204 is illustrated as a separate program from the signal generation program 202, but in some cases the signal generation program and position control program may reside in the same overall software package. The position control program 204 may be viewed as an interface with which a trader interacts to enter multiple positions regarding securities tracked by the signal generation program 202. More particularly, the position control program 204 enables the trader 102 to set various parameters regarding positions to be entered, and the position control program 204 then enters positions within the parameters set by the trader 102, the entering (and in some cases exiting) without further action by the trader 102. Thus, the trader 102 need not tediously initiate individual transactions for individual securities, or make binary decision on whether to enter a basket trade, all the while separately tracking the amounts expended in the purchasing accounts.

In particular, the trader 102 interacts with the position control program by way of a physical device, and thereby sets at least an indication of purchasing power for entering positions. Without further input by the trader 102, the position control program selects a plurality of securities from a preselected list of securities that are tracked by the signal generation program. The securities are selected from the preselected list of securities based on signals created by the signal generation program. Once the securities are selected, the position control program enters a plurality of positions regarding the securities, with the number and value of the plurality of positions limited by the purchasing power set by the trader. Stated otherwise, the trader 102 does not select which securities, from the preselected of securities, for which positions will be entered. The position control program 204, based on the signals from the signal generation program 202, makes the selection. For purposes of this specification and the claims, designating by the trader 102 the securities on the preselected list shall not be construed as selecting securities for which positions will be entered. The preselected list of securities may be very large and yet only a few positions regarding a respective few securities may be entered by the position control program 204. Moreover, the trader 102 devising the strategies from which signals are generated shall not be construed as selecting securities for which positions will be entered. The trader does not know, when devising such strategies, whether the logic underlying the strategy will be true at the point in time that a selection of securities is made for entry of positions.

In one embodiment, the trader 102 need merely provide the position control program 204 an indication of purchasing power, and from the indication of purchasing power and the signals from the underlying signal generation program 202 the position control program enters a plurality of positions. In another embodiment, however, additional information applicable to the type of positions to enter may also be supplied to the position control program 204. In particular, in another embodiment the trader 102 sets or provides an indication of a number of long transactions to a number of short transactions the position control program should enter with respect to the selected purchasing powering. Stated otherwise, an indication is provided as to the relationship between the number of long transactions and the number of short transactions to be entered by the position control program 204. Thereafter, the position control program 204 enters positions consistent with the indication of a number of long transactions to a number of short transactions.

In some cases, the indication of the relationship of long and short transactions involves setting a ratio of long transactions to short transactions. In a particular embodiment, the following selections may be made: all long transactions; three long transactions to one short transaction; two long transactions to one short transaction; one long transactions to one short transaction; one long transaction to two short transactions; one long transaction to three short transactions; and all short transactions. Much like interacting with the position control program 204 to set purchasing power, the trader 102 interacts with the position control program 204 by way of a physical device to provide the indication of the number of long transactions to the number of short transactions.

In yet another embodiment, in addition to the indication of purchasing power (and optionally the indication of the relationship of long and short transactions), information related to stop loss criterion (also known as a “choke”) may also be supplied to the position control program 204. In particular, the trader 102 may set a stop loss criterion with the position control program 204. When the stop loss criterion is met or exceeded with respect to one more of the positions entered by the position control program 204, the position control program 204 exits one or more of the positions.

The stop loss criterion may be used both for long and short transactions. For example, a stop loss criterion for a long transaction may set a price for security that, if the price retreats to or below the stop loss criterion, the position control program 204 will sell the security. Likewise for short transactions, a stop loss criterion for a short transaction may set a price for security that, if the price increases to or exceeds stop loss criteria, the position control program 204 will purchase the security (thus completing the short transaction). In a particular embodiment then, stop loss criteria may be based on position price. However, since a plurality of positions may be entered by the position control program 204, all at varying prices, rather than set an absolute price the stop loss criterion may be set as a percentage, within a preselected range of percentages, where the percentage indicates the stop loss criterion as a function of position price. For example, if a stop loss criterion is set by the trader 102 as 3%, when the price of a security for which a long transaction has been entered falls by 3% or more, the position control program 204 exits the position. In some cases, the price to which the stop loss criteria as a percentage applies is the initial position price; however, in other cases the trader 102 may “reset” the price to which the stop loss criteria applies. For example, if the trader sees a 10% gain in trading price for a security for which a long transactions has been entered, the trader 102 may “reset” the price to which the stop loss criterion applies such that a retreat from the price at reset (rather than the initial purchase price) triggers the position control program 204 to exit the position based on the stop loss criterion.

As another example of operation of the stop loss criterion, if a stop loss criterion is set by the trader 102 as an illustrative 3%, when the price of a security for which a short transaction has been entered rises by 3% or more, the position control program 204 exits the position. Here again, the price to which the stop loss criterion as a percentage applies is the initial position price; however, in other cases the trader 102 may “reset” the price to which the stop loss criterion applies. Thus, in this example for short transactions, if the trader sees a 10% loss in trading price for a security for which a short transaction has been entered, the trader 102 may “reset” the price to which the stop loss criterion applies such that an increase from the price at reset (rather than the initial position price) triggers the position control program 204 to exit the position based on the stop loss criteria. Much like interacting with the position control program 204 to set purchasing power, the trader 102 interacts with the position control program 204 by way of a physical device to provide the stop loss criteria.

Interacting with a physical device to provide any or all of the indication of purchasing power, indication of relationship of long and short transactions, and stop loss criteria may take many forms. In some cases the interaction may be way of a computer monitor and pointing device, such as a mouse or touch-screen associated with the monitor. In other cases, physical device distinct from the trader computer system 200 and its components, yet communicatively coupled to the trader computer system 200, may be used.

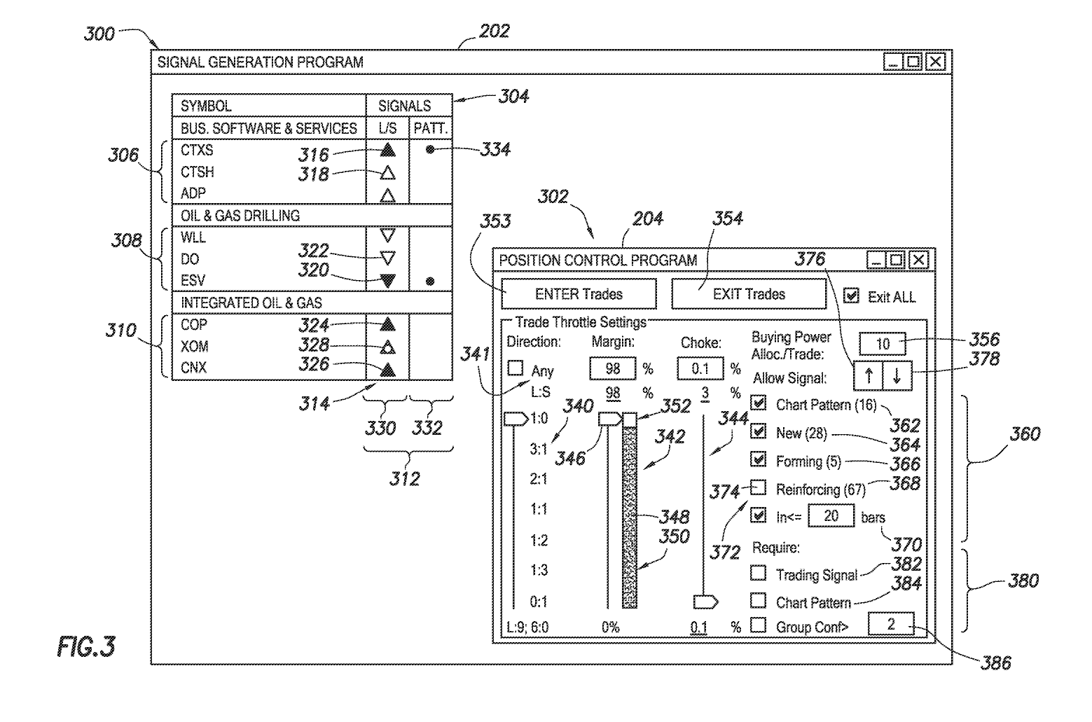

FIG. 3 shows an illustrative user interface, such as may be shown on a display device of a trader computer system 200, in accordance with at least some embodiments. In particular, FIG. 3 shows a user interface 300 for signal generation program 202, as well as a user interface 302 for the position control program 204, with the user interface 302 for the position control program 204 overlaid on the user interface 300 for the signal generation program.

As discussed above, the signal generation program 202 tracks securities in a preselected list of securities. In FIG. 3, the preselected list of securities is shown in section 304. As illustrated, nine different illustrative letter symbols for specific securities are tracked by the signal generation program; however, any number of securities may be tracked. The letter symbols shown are illustratively grouped into industries. For example, section 304 of the user interface 300 has the following illustrative groups: group 306 for securities related to business software and services; group 308 for securities related to oil and gas drilling; and group 310 for securities related to integrated oil and gas services. While three illustrative groups are presented, any number of groups may be equivalently used.

The signal generation program 202 generates signals regarding the preselected list of securities, and in the illustrative user interface 300 of FIG. 3 the signals are shown in the form of graphical symbols in column 312. In FIG. 3, there is a graphical symbol associated with security stock symbol; however, the signal generation program 202 need not provide a signal if the particular security does not warrant a recommendation implied by a signal. Signals may be created for a variety of underlying strategies (as discussed above), and the signals may be presented in a variety of forms. In the illustrate case of FIG. 3, the signals are present by way of plurality of graphical symbols 314. For example, illustrative graphical symbol 316 in the form of a solid triangle with an apex above the base may be a signal that recommends entering a long transaction with the respect to the illustrative security represented by the stock symbol “CTXS”. In some cases, the graphical symbol 316 may also have a fill color associated with long transactions, such as a green fill color. Other colors representing long transactions may be equivalently used. Within the same group 306, graphical symbol 318 in the form of a hollow triangle with an apex above the base may be a signal indicating that a recommendation is forming regarding illustrative security represented by the stock symbol “CTSH”—a “forming signal”. In some cases, the lines that form graphic symbol 318 may be drawn in a color to convey the forming signal is a forming signal for a long transaction, such as drawn in green lines.

Still referring to FIG. 3, as yet another example of the graphical symbols for signals created, illustrative graphical symbol 320 in the form of a solid triangle with an apex below the base may be a signal that recommends entering a short transaction with the respect to the illustrative security represented by the stock symbol “ESV”. In some cases, the graphical symbol 320 may also have a fill color associated with short transactions, such as a red fill color. Other colors representing short transactions may be equivalently used. Within the same group 308, graphical symbol 322 in the form of a hollow triangle with an apex below the base may be a signal indicating that a recommendation is forming regarding illustrative security represented by the stock symbol “DO”. In some cases, the lines that form graphic symbol 322 may be drawn in a color to convey the forming signal is a forming signal for a short transaction, such as drawn in red lines.

Other types of signals may be created by the signal generation program 202, such as signals that reinforce other signals. For example, in group 310 there are two illustrative symbols indicating signals to enter long transactions, graphical symbols 324 and 326 associated with stock symbols “COP” and “CVX” respectively. Graphical symbol 328, within the same group 310, illustrates a signal that merely reinforces other signals. In particular, graphical symbol 328 in the form of a triangle with an apex above the base, and containing another graphical symbol with the triangle (illustratively a circle) may be a signal indicating that other signals are reinforced based on data associated with the stock symbol—a “reinforcing signal”.

Still referring to FIG. 3, the signals generated by the signal generation program 202 may also be based on an analysis of other signals. Consider again group 306, containing signal 316 and signal 318. The column 312, in addition to having a long/short (“L/S”) section 330 where some graphical symbols are illustratively located, also contains a section 332 where graphical symbols regarding patterns (“Patt.”) are displayed. The signals presented in column 332 may be based on patterns of other signals. For example, graphical symbol 334, in the illustrative form a solid circle, may indicate that the signal associated with graphical symbol 316 is also part of a pattern within any suitable group of stock symbols, here the group 306. In some cases, the fill color for the graphical symbol 334 may be a color to convey the nature of the pattern, such as a fill color of green when the pattern indicates a bullish move for the group, or red when the pattern indicates a bearish move for the group.

The graphical symbols, and the respective presentation on the user interface 300, are merely illustrative. Other symbols presenting signals regarding underlying strategies may be equivalently used. Moreover, other symbols are also possible, such as graphical symbols indicating the trader 102 is already in a position regarding the security (e.g., up arrow indicating an active long transaction, downward arrow indicating an active short transaction). Further still, while FIG. 3 shows the graphical symbols as a basis for the reader's understanding of signals, and how such signals may be used by the position control program (discussed more below), in some cases the trader 102 need not be presented the signals; rather, the signals created by the signal generation program may be electronically conveyed to the position control program 204.

FIG. 3 further shows an illustrative user interface 302 for the position control program 204. The user interface 302 illustrates embodiments where multiple pieces of information are conveyed to the position control program 204 by the trader 102, with the primary piece of information being an indication of the relationship of long and short transactions by way of control device 340, an indication of purchasing power by way of control device 342, and an indication of stop loss or “choke” by way of control device 344. Each of the control devices are illustratively shown as “analog” sliders, and more particularly linear “analog” sliders, but any suitable control device may be equivalently used. The term “analog” here means that physical position of the slider conveys desired information, but should not be read to require an underlying analog electrical system.

Control device 340 illustratively sets the relationship of long and short transactions, and as shown enables the trader 102, by way of interaction with the control device 340, to select from a range ratios of long to short transactions. The range illustrated comprises: all long transactions; three long transactions to one short transaction; two long transactions to one short transaction; one long transaction to one short transaction; one long transaction to two short transactions; one long transaction to three short transactions; and all short transactions. Thus, when such settings are used by the position control program 204, the position control program 204 selects and enters positions with the selection and positions entered in substantial conformance with the indication of relationship set by the control device 340. It should be understood, however, that selection may be a sequential process, and thus securities at an intermediate point in the overall selection process may not precisely meet the illustrative ratio. Moreover, entering positions is not an instantaneous occurrence given the parties involved (see FIG. 1) in implementing positions, and thus securities for which positions have been entered at an intermediate point in the overall process may not precisely meet the illustrative ratio. Moreover, as discussed with respect to the stop loss criteria, positions may be exited at particular times, and in some embodiments the position control program does not attempt to enter further positions to maintain the relationship of the long and short transactions. Thus, over time the relationship of long and short transactions may diverge from the initial indication set by the trader 102.

In another embodiment the position control program 204 may enter trades independent of the relationship of long to short transactions. In the illustrative user interface 302 of FIG. 3, such a configuration is selected by check-box 341 (labeled “Any”). When the check-box 341 is selected, the relationship of the long and short transactions indicated by the slider 340 is not used by the position control program 204, and the position control program may enter any number of positions (long or short) consistent with the other information provided.

Control device 342 illustratively sets the indication of purchasing power, and illustratively enables the trader 102, by way of interaction with the control device 342, to select purchasing power as a percentage of margin. Other indications of purchasing power may be used, such as percentage of total account balance, or a dollar figure in the range from zero to total account balance. In the illustrative case of FIG. 3, the slider 346 position sets the indication of purchasing power, and the window 348 may provide a real time, or near real time, indication of purchasing power actually used. For example, darker region 350 may show how much of the purchasing power has been allocated in entered positions, and the lighter region 352 may indicate remaining available purchasing power. In some cases differing colors may convey similar information. Thus, the position control program 204 selects and enters positions with based on the indication of purchasing power in substantial conformance with the indication as set by the control device 342. It should be understood, however, that entering positions may be a sequential process, and thus the purchasing power actually used at an intermediate point in the overall position entering process may not precisely match the selected purchasing power. Moreover, the price for entering positions may vary, and thus the relationship of pricing of the positions may not allow entering positions to precisely match the allocated purchasing power. In some cases, there may not be a sufficient number of signals to enter positions consistent with the indication of purchasing power. Moreover, as discussed with respect to the stop loss criteria, positions may be exited at particular times, and in some embodiments the position control program does not attempt to enter further positions. Thus, over time the amount of purchasing power actually used may drop well below the indication of purchasing power.

Control device 344 illustratively sets the stop loss criterion. In the illustrative example of FIG. 3, the stop loss criterion is set as a percentage within a range from 0.1% to 3%; however, the trader 102 may set the range of the percentage for the stop loss criterion at any suitable range. The position control program 204 may exit positions as the positions meet or exceed the stop loss criterion.

In some cases, positions may be entered based the instantaneous position of the control devices 340, 342, and 344. However, in other cases the position control program may not select securities and enter positions until expressly informed to do so, such as by way of the “ENTER Trades” push-button device 353. That is, various criteria regarding the positions may be entered by the control devices 340, 342, and 344, but the data associated with the control devices may not be read, and the underlying work of the position control program 204 may not commence, until the push-button device 353 is activated. Other mechanisms to inform the position control program to proceed may be equivalently used. Likewise, in some cases a trader may desire to exit all positions, even positions making money, by way of the “EXIT Trades” push-button device 354. Other mechanisms to inform the position control program to proceed may be equivalently used, such as a changing the stop loss criteria to a negative percentage.

In some embodiments the allocation of the purchasing power set by the trader 102 is determined by the position control program 204 without further input from the trader 102. In other embodiments, however, the trader 102 may set the allocation of the purchasing power by way of a dialog box 356 (labeled “Buying Power Alloc./Trade:” in FIG. 3). Any of variety of indications may be provided by way of the dialog box 356. For example, the dialog box may accept a direct indication of the number of positions to be entered (which may be limited by the relationship of long and short transactions). In another case, the diaglog box may accept an indication of percentage of purchasing power to be allocated to each position. For example, an indication of 10% in dialog box 356 may indicate that 10% of the indicated purchasing power be allocated to each position. Thus, if the indication of purchasing power makes available $200,000, with an indication of 10% each position is allocated $20,000. As before, a variety of factors may not allow position control program to precisely use the allocated portion.

Still referring to FIG. 3, the illustrative user interface 302 for the position control program 204 also comprises a section 360 where the trader 102 can prioritize and/or control the signals used by the position control program 204 to make the selections of positions. For user illustrative interface 302, five criteria are listed: chart pattern signal category 362 (positions with signals in the form of identified patterns); new signal category 364 (the signal is not older than some predetermined time); forming signal category 366 (a position can be entered on a forming signal); reinforcing signal category 368 (a position should have a reinforcing indication); and time signal category 370, labeled “In<=[some number of] bars” (an indication of the age of the signal upon which to base a decision regarding a position). Moreover, in a particular embodiment the priority among the categories is established by the order within section 360. Thus, in the illustrative example of FIG. 3, decisions regarding positions are made by the position control program 204 first on chart patterns, then new signals, then forming signals, and finally on signals less than or equal to 20 bars (a selectable measure of time) old. Moreover, the categories may be selectively used by way of check boxes 372. In the example of FIG. 3, the reinforcing category is not used, based on the lack of selection in check box 374.

Inasmuch as the priorities are established based on order in section 360, the order of the categories may be changed by operation of push-buttons 376 and 378. A category may be highlighted, and the position on the category on the list changed by operation of push-buttons 376 and/or 378. For example, the reinforcing category 368 may be moved to the first position in the list in section 360, such that reinforcing signals are the first criteria used to narrow the list of possible securities. The list of categories in section 360 is merely illustrative, and other categories may be equivalently used.

In addition to the priorities in the section 360, in yet still further embodiments the trader may set required signals for the position control program 204 by way of section 380. That is, the trader 102 may determine that some signals must be present for the position control program 204 to select the security for position entry. Section 380 illustratively shows three categories: Trading Signals category 382 (which, if checked, illustratively requires a signal that expressly recommends a position regarding the security); Chart Pattern category 384 (which, if checked, illustrative requires a chart pattern signal to be present regarding the security); and Group Confirm category 386 (labeled “Group Conf >”) (which, if checked, illustratively requires a least a predetermined number of similar signals in a group). Like section 360, the requirements in section 380 are applied top to bottom, and the relative position of any particular category can be changed by interaction with push-buttons 376 and/or 378.

Thus, based on the indications provided by way of user interface 302, the position control program 204 may select positions regarding securities, enter positions consistent with the indication of purchasing power (and consistent with indication of relationship of long and short transactions, if used), and eventually exit the positions, either by direct indication of the trader 102, or by the position meeting stop loss criteria (if used).

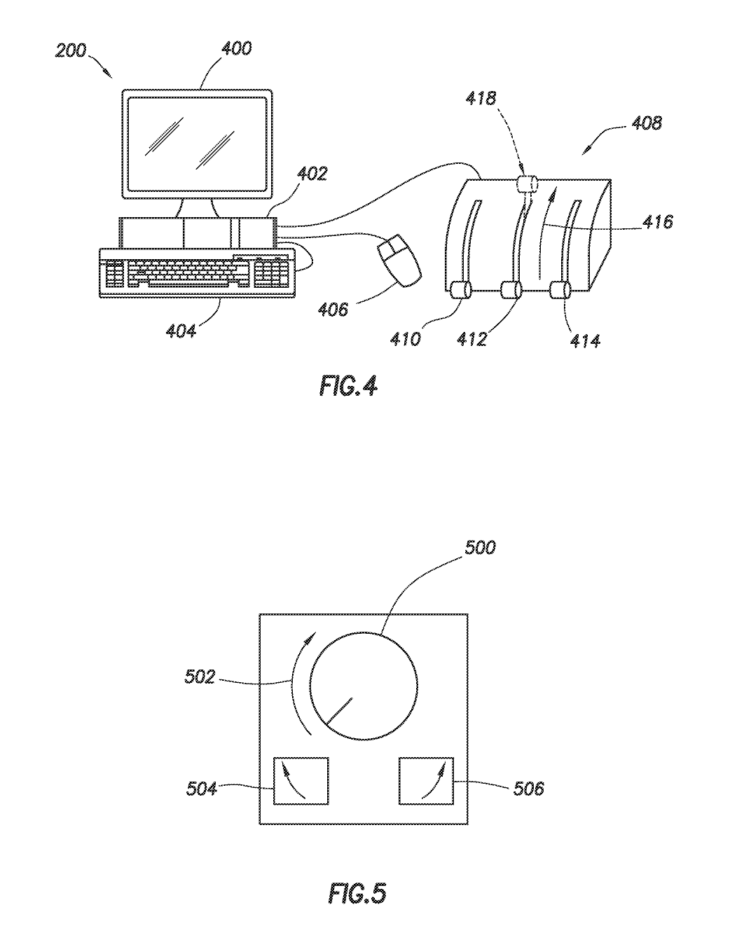

In the illustrative embodiments of FIG. 3, the trader 102 interacts with a physical device being a control device depicted on a display of a computer system; however, in other embodiments the control device may be a separate and distinct physical device from the display of the computer system. FIG. 4 illustrates embodiments where the control device is separate and distinct from the computer system. In particular, FIG. 4 shows trader computer system 200. In the example embodiment of FIG. 4, the trader computer system 200 comprises a display device 400, computer chassis 402 (within which various components reside, such as a processor and hard drive), a keyboard 404, and pointing device 406 (e.g., a “mouse”). Distinct from the various components that make up the computer system 200, the system further comprises a control device 408 communicative coupled to the computer system. The control device 408 has a plurality of “analog” levers, and in the illustrative embodiments three such levers 410, 412, and 414 are shown. The term “analog” here only refers to the interaction method, and does not speak to how different positions of each lever are measured electrically. In some cases, the movement and position of each lever may be measured digitally, and yet the levers still considered as “analog” because of the interaction mechanism. Lever 410 may be used to set the relationship of the long and short transactions. Lever 412 may be used to set the purchasing power. Lever 414 may be used to set the stop loss. Movement of each lever causes a change in the respective parameter to which the lever applies. FIG. 4 illustrates movement of the lever 412 by way of arrow 416, and also illustrative shows lever 412 in its fully forward position, as location 418.

The control device 408 may take any suitable form. In a particular embodiment, the control device 408 is a throttle quadrant for a flight simulation or flight trainer program. For example, in one embodiment the control device 408 is a Saitek® brand single engine throttle quadrant for a flight simulator available from Mad Catz Inc. of San Diego, Calif.

The sliders 340, 342, and 344 of FIG. 3, as well as the levers 410, 412, and 414, are merely illustrative of the types of devices with which a trader 102 may interact to provide information to the position control program 204. Other types of devices, whether distinct from the computer system 200 or depicted on a display of the computer system 200, may be used. FIG. 5 shows example alternatives. In particular, FIG. 5 shows a control device in the form of a knob 500 (i.e., a rotational slider) that rotates to make a change in an indication, such as purchasing power. The rotation of the knob is illustrated by arrow 502. In other embodiments, position of the control device may be indirectly controlled, such as by push-buttons. FIG. 5 illustrated push-buttons 504 and 506 as mechanism to change the position of knob 500. That is, by interacting with push-button 504, movement of the control device instigated, in this illustrative case clockwise movement. By interacting with push-button 506, movement of the control device is also instigated, in this illustrative case counter-clockwise movement. Use of the push-buttons 504 and 506 with the knob 500 is merely illustrative, and push-buttons may be used to interact with other control devices, such as sliders.

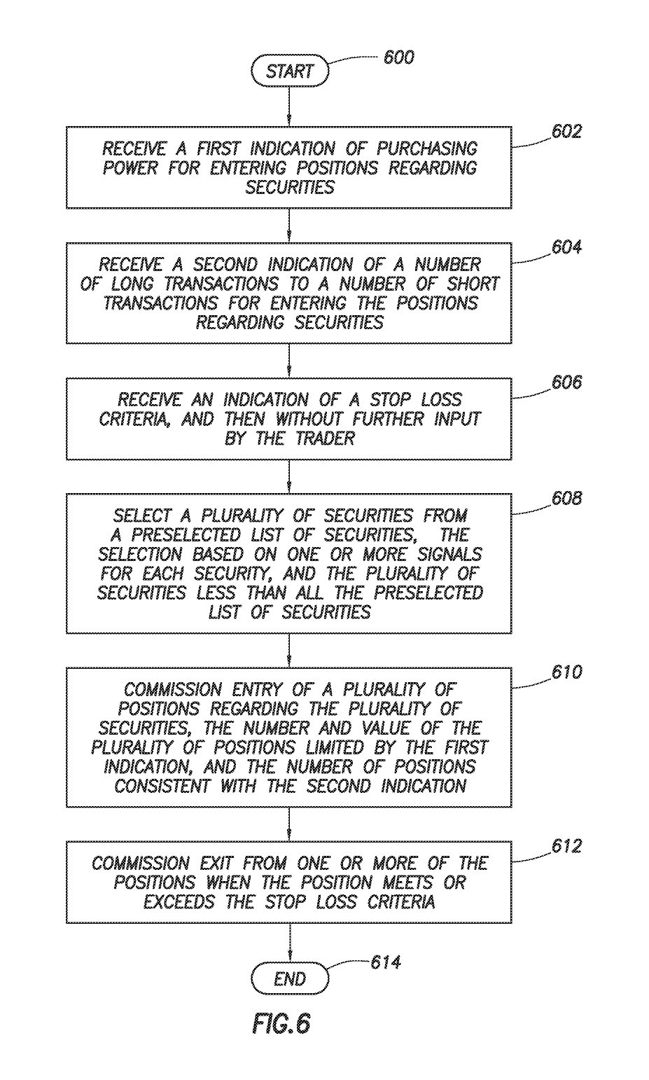

FIG. 6 shows a method, which may be implemented in software, in accordance with at least some embodiments. In particular, the method starts (block 600) and proceeds to: receive a first indication of purchasing power for entering positions regarding securities (block 602); receive a second indication of a number of long transactions to a number of short transactions for entering the positions regarding securities (block 604); receive an indication a stop loss criteria (block 606) and then without further input by the trader; select a plurality of securities from a preselected list of securities, the selection based on one more signals for each security, and the plurality of securities less than all the preselected list of securities (block 608); commission entry of a plurality of positions regarding the plurality of securities, the number and value of the plurality of positions limited by the first indication, and the number of positions consistent with the second indication (block 610); and commission exit from one or more of the positions when the position meets or exceeds the stop loss criteria (block 612). Thereafter, the method ends (block 614).

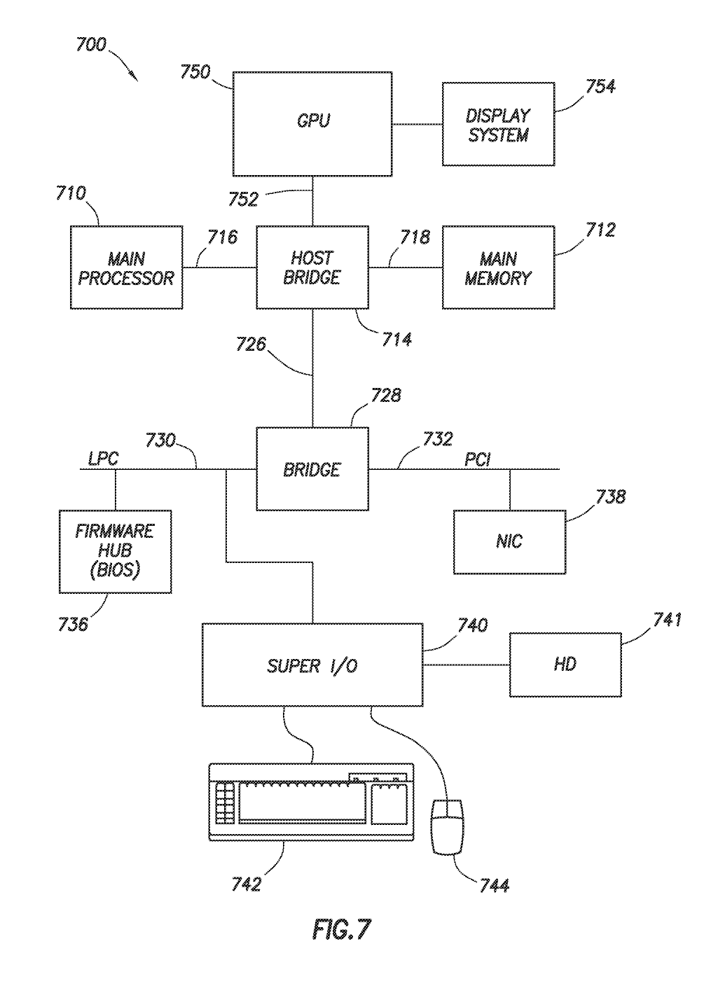

FIG. 7 illustrates a computer system 700 in accordance with at least some embodiments, and upon which at least some of the various embodiments may be implemented. That is, some or all of the various embodiments may execute on a computer system such as shown in FIG. 7, multiple computers systems such as shown in FIG. 7, and/or one or more computer systems equivalent to the FIG. 7, including after-developed computer systems.

In particular, computer system 700 comprises a main processor 710 coupled to a main memory array 712, and various other peripheral computer system components, through integrated host bridge 714. The main processor 710 may be a single processor core device, or a processor implementing multiple processor cores. Furthermore, computer system 700 may implement multiple main processors 710. The main processor 710 couples to the host bridge 714 by way of a host bus 716 or the host bridge 714 may be integrated into the main processor 710. Thus, the computer system 700 may implement other bus configurations or bus-bridges in addition to, or in place of, those shown in FIG. 7.

The main memory 712 couples to the host bridge 714 through a memory bus 718. Thus, the host bridge 714 comprises a memory control unit that controls transactions to the main memory 712 by asserting control signals for memory accesses. In other embodiments, the main processor 710 directly implements a memory control unit, and the main memory 712 may couple directly to the main processor 710. The main memory 712 functions as the working memory for the main processor 710 and comprises a memory device or array of memory devices in which programs, instructions and data are stored. The main memory 712 may comprise any suitable type of memory such as dynamic random access memory (DRAM) or any of the various types of DRAM devices such as synchronous DRAM (SDRAM) (including double data rate (DDR) SDRAM, double-data-rate two (DDR2) SDRAM, double-data-rate three (DDR3) SDRAM, extended data output DRAM (EDODRAM), or Rambus DRAM (RDRAM). The main memory 712 is an example of a non-transitory computer-readable medium storing programs and instructions, and other examples are disk drives and flash memory devices.

The illustrative computer system 700 also comprises a second bridge 728 that bridges the primary expansion bus 726 to various secondary expansion buses, such as a low pin count (LPC) bus 730 and peripheral components interconnect (PCI) bus 732. Various other secondary expansion buses may be supported by the bridge device 728. In accordance with some embodiments, the bridge device 728 comprises an Input/Output Controller Hub (ICH) manufactured by Intel Corporation, and thus the primary expansion bus 726 comprises a Hub-link bus, which is a proprietary bus of the Intel Corporation. However, computer system 700 is not limited to any particular chip set manufacturer, and thus bridge devices and expansion bus protocols from other manufacturers may be equivalently used.

Firmware hub 736 couples to the bridge device 728 by way of the LPC bus 730. The firmware hub 736 comprises read-only memory (ROM) which contains software programs executable by the main processor 710. The software programs comprise programs executed during and just after POST.

The computer system 700 further comprises a network interface card (N IC) 738 illustratively coupled to the PCI bus 732. The NIC 738 acts as to couple the computer system 700 to a communication network, such the Internet.

Still referring to FIG. 7, computer system 700 may further comprise a super input/output (I/O) controller 740 coupled to the bridge 728 by way of the LPC bus 730. The Super I/O controller 740 controls many computer system functions, for example interfacing with various input and output devices such as a keyboard 742, a pointing device 744 (e.g., mouse), various serial ports, floppy drives and hard disk drives (HD) 741. The hard disk drive 741 is another example of a computer-readable media. In other cases, the hard disk drive 741 may couple to a separate drive controller coupled to a more powerful expansion bus, such as the PCI bus 732, particularly in cases where the hard disk drive is implemented as an array of drives (e.g., redundant array of independent (or inexpensive) disks (RAID)). In cases where the computer system 700 is a server computer system, the keyboard 742 and pointing device 744 may be omitted.

The computer system 700 further comprises a graphics processing unit (GPU) 750 coupled to the host bridge 714 by way of bus 752, such as a PCI Express (PCI-E) bus or Advanced Graphics Processing (AGP) bus. Other bus systems, including after-developed bus systems, may be equivalently used. Moreover, the graphics processing unit 750 may alternatively couple to the primary expansion bus 726, or one of the secondary expansion buses (e.g., PCI bus 732). The graphics processing unit 750 couples to a display system 754 which may comprise any suitable electronic display device or multiple distinct display devices, upon which any image or text can be displayed, such as the control devices to interact with the position control program 204. In some case, such as the computer system 700 operated as server computer system, the graphics processing unit 750 and display system 754 may be omitted.

From the description provided herein, those skilled in the art are readily able to combine software created as described with appropriate general-purpose or special-purpose computer hardware to create a computer system and/or computer sub-components in accordance with the various embodiments, to create a computer system and/or computer sub-components for carrying out the methods of the various embodiments, and/or to create a non-transitory computer-readable storage medium (i.e., other than an signal traveling along a conductor or carrier wave) for storing a software program to implement the method aspects of the various embodiments.

The method steps, user interface layouts, displays, and other components described herein can be implemented on any computer, network, or other apparatus capable of performing the functions described. No limitation as to operation on a particular type of system or apparatus is implied. No particular programming language is required; rather, any type of programming language can be used to implement the various embodiments.

References to “one embodiment”, “an embodiment”, “a particular embodiment” indicate that a particular element or characteristic is included in at least one embodiment of the invention. Although the phrases “in one embodiment”, “an embodiment”, and “a particular embodiment” may appear in various places, these do not necessarily refer to the same embodiment.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method comprising:
interacting by a trader with a physical device, the interacting sets purchasing power for entering positions regarding securities; and without further input by the trader
selecting a plurality of securities from a preselected list of securities, the selecting based on one or more indications for each security, and the selecting by a computer system;
entering a plurality of positions regarding the plurality of securities, the number and value of the plurality of positions limited by the purchasing power, and the entering initiated by the computer system.

2. The method of claim 1 wherein interacting further comprises interacting with a control device depicted on a computer monitor coupled to the computer system.

3. The method of claim 2 wherein interacting further comprises interacting with at least one selected from the group consisting of: a linear slider; and a rotational slider.

4. The method of claim 2 wherein interacting further comprises interacting with push-buttons that change position of the control device.

5. The method of claim 1 wherein interacting with the physical device further comprises interacting with a control device distinct from the computer system, the analog control device coupled to the computer system.

6. The method of claim 1 further comprising:
wherein interacting further comprises setting an indication of a number of long transactions to a number of short transactions; and
wherein entering the plurality of positions further comprises entering the plurality of positions consistent with the indication.

7. The method of claim 6 wherein setting the indication further comprises setting a ratio of long transactions to short transactions.

8. The method of claim 7 wherein setting the ratio further comprises selecting at least one from the group consisting of: all long transactions; and all short transactions.

9. The method of claim 6 wherein setting the ratio further comprises selecting at least one ratio from the group consisting of: three long transactions to one short transaction; two long transactions to one short transaction; one long transaction to one short transaction; one long transaction to two short transactions; and one long transaction to three short transactions.

10. The method of claim 1 further comprising:
wherein interacting further comprising setting a stop loss criteria based on position price; and without further input by the trader
exiting one or more of the positions when the position meets or exceeds the stop loss criteria, the exiting initiated by the computer system.

11. The method of claim 10 wherein setting the stop loss criteria further comprises selecting a percentage of position entry price within a preselected range of percentages

12. The method of claim 1 wherein entering the plurality of positions further comprises sending a market order to a clearing house, the sending by way of an electronic message.

13. A computer system comprising:
a processor;
a display device coupled to the processor;
a memory coupled to the processor, the memory stores a program that, when executed by the processor, causes the processor to:
receive, from a trader, a first indication of purchasing power for entering positions regarding securities; and
receive, from the trader, a second indication of a number of long transactions to a number of short transactions for entering the positions regarding securities; and then without further input from the trader
select a plurality of securities from a preselected list of securities, the selection based on one more signals for each security, and the plurality of securities less than all the preselected list of securities; and
commission entry of a plurality of positions regarding the plurality of securities, the number and value of the plurality of positions limited by the first indication, and the number of positions consistent with the second indication.

14. The computer system of claim 13 wherein when the processor receives the first indication, the program causes the processor to:
display an interactive analog control device on the display device; and
receive the first indication as the location of the interactive analog control device.

15. The computer system of claim 14 wherein when the processor displays the interactive analog control device, the program causes the processor to display at least one selected from the group consisting of: a linear slider; and a rotational slider.

16. The computer system of claim 14 wherein when the processor receives the first indication, the program further causes the process to receive the first indication by way of interaction of the trader with push-buttons that change position of the analog control device.

17. The computer system of claim 13 wherein the processor receives the first indication, the program further causes the processor to receive the first indication from an analog control device, distinct from the computer system, the analog control device coupled to the computer system.

18. The computer system of claim 13 wherein when the processor receives the second indication, the program further causes the processor to receive the second indication in the form of a ratio.

19. The computer system of claim 18 wherein when the processor receives the second indication, the program causes the processor to receive at least one ratio selected from the group consisting of: three long transactions to one short transaction; two long transactions to one short transaction; one long transactions to one short transaction; one long transaction to two short transactions; and one long transaction to three short transactions.

20. The computer system of claim 13 further comprising:
wherein the program further causes the processor to receive an indication of a stop loss criteria; and then without further input by the trader the program causes the processor to
commission exit from one or more of the positions when the position meets or exceeds the stop loss criteria.

21. The computer system of claim 20 wherein when the processor receives the indication of stop loss criteria, the program causes the processor to receive an indication of a percentage of position entry price within a preselected range of percentages.

22. A non-transitory computer-readable medium storing instructions that, when executed by a processor, cause the processor to:
receive, from a trader, a first indication of purchasing power for entering positions regarding securities
receive, from the trader, a second indication of a number of long transactions to a number of short transactions for entering the positions regarding securities; and then without further input from the trader
select a plurality of securities from a preselected list of securities, the selection based on one or more signals for each security, and the plurality of securities less than all the preselected list of securities;
initiate entry of a plurality of positions regarding the plurality of securities, the number and value of the plurality of positions limited by the first indication, and the number of positions consistent with the second indication.

23. The non-transitory computer-readable medium of claim 22 wherein the program further causes the processor to:
receive, from the trader, an indication of a stop loss criteria; and
initiate exit from one or more of the positions when the position meets or exceeds the stop loss criteria.

24. The non-transitory computer-readable medium of claim 23 wherein when the processor receives the indication of stop loss criteria, the program causes the processor to receive an indication of a percentage of position entry price within a preselected range of percentages.

25. The non-transitory computer-readable medium of claim 23 wherein when the processor receives the indication of stop loss criteria, the program causes the processor to receive an indication of a percentage of position entry price within a preselected range of percentages.

26. The non-transitory computer-readable medium of claim 23 wherein when the processor receives the first indication, the program causes the processor to:
display an interactive control device on the display device; and
receive the first indication of purchasing power as the position of the interactive control device.

27. The non-transitory computer-readable medium of claim 26 wherein when the processor displays the interactive control device, the program causes the processor to display at least one selected from the group consisting of: a linear slider; and a rotational slider.

28. The non-transitory computer-readable medium of claim 23 wherein the processor receives the first indication of purchasing power, the program further causes the processor to receive the indication from a control device, distinct from a computer system in which the processor is disposed, the control device coupled to processor.

29. The non-transitory computer-readable medium of claim 23 wherein when the processor receives the second indication, the program further causes the processor to receive the second indication in the form of a ratio.

30. The non-transitory computer-readable medium of claim 29 wherein when the processor receives the second indication, the program causes the processor to receive at least one ratio selected from the group consisting of: three long transactions to one short transaction; two long transactions to one short transaction; one long transaction to one short transaction; one long transaction to two short transactions; and one long transaction to three short transactions.
